(19) United States
(12) Patent Application Publication
(10) Pub. No.: US 2020/0306627 A1
(43) Pub. Date: Oct. 1, 2020

(54) METHOD FOR PROMPTING POSITION OF GAME CHARACTER, TERMINAL DEVICE, AND STORAGE MEDIUM

(71) Applicant: AAC Technologies Pte. Ltd., Singapore city (SG)

(72) Inventor: Xiuyue Wang, Shenzhen (CN)

(21) Appl. No.: 16/729,505

(22) Filed: Dec. 30, 2019

(30) Foreign Application Priority Data
Mar. 28, 2019 (CN) 201910242918.X

(51) Int. Cl. A63F 13/285; A63F 13/2145; G06F 3/01

(52) U.S. Cl. CPC A63F 13/285; G06F 3/016; A63F 13/2145

(57) ABSTRACT

The present invention discloses a method for prompting position of a game character, a terminal device, and a storage medium. The method is applied to the terminal device, which includes a display screen, a first prompting device, and a second prompting device. The display screen includes a first prompt area corresponding to the first prompting device, and a second prompt area corresponding to the second prompting device. The method includes: acquiring a first position information of a first game character in a game screen; determining whether the first game character is in the first prompt area or the second prompt area according to the first position information; controlling the first prompting device to generate prompt information when the first game character is in the first prompt area; and/or controlling the second prompting device to generate prompt information when the first game character is in the second prompt area.

### FIELD OF THE PRESENT DISCLOSURE

The present disclosure relates to the field of communication technology, and more particularly to a method for prompting position of game characters, a terminal device, and a storage medium.

### DESCRIPTION OF RELATED ART

With the development of portable electronic technology, terminal device is currently no longer a simple device for call, it has gradually become a platform for running general softwares. The platform no longer mainly aims to provide call management, but provides an operating environment for call management, game entertainment, office notes, mobile payment, and other applications. With a lot of popularity, the terminal device has penetrated into every aspect of people's life and work.

With the popularity of games on terminal devices, how to improve user's gaining experience has become a technical problem that technicians need to solve urgently.

### SUMMARY OF THE PRESENT DISCLOSURE

The present disclosure is to provide a method for prompting position of game characters, a terminal device, and a storage medium, aiming to improve the user's gaining experience on terminal devices.

To achieve the above object, the present disclosure provides a method for prompting position of a game character, which is applied to a terminal device. The terminal device includes a display screen, a first prompting device, and a second prompting device. The display screen includes a first prompt area and a second prompt area, the first prompting device is set to correspond to the first prompt area, and the second prompting device is set to correspond to the second prompt area. The method for prompting position includes: acquiring a first position information of a first game character in a game screen; determining whether the first game character is in the first prompt area or the second prompt area according to the first position information; controlling the first prompting device to generate prompt information when the first game character is in the first prompt area; and/or controlling the second prompting device to generate prompt information when the first game character is in the second prompt area.

In some embodiments, the first prompting device and the second prompting device are a first vibrating device and a second vibrating device respectively, and controlling the first prompting device and/or the second prompting device to generate prompt information specifically includes: controlling the first vibrating device and/or the second vibrating device to vibrate.

In some embodiments, the operation of controlling the first vibrating device and/or the second vibrating device to vibrate includes: acquiring a second position of a second game character in the game screen; calculating a distance between the first game character and the second game character; calculating to obtain a vibration controlling information for controlling the vibration of the first vibrating device and/or the second vibrating device according to the distance, wherein the vibration controlling information is configured to control the first vibrating device and/or the first vibrating device to vibrate; driving the first vibrating device and/or the second vibrating device to vibrate based on the vibration controlling information.

In some embodiments, the operation of calculating to obtain the vibration controlling information for controlling the vibration of the first vibrating device and/or the second vibrating device according to the distance, includes: determining whether the distance exceeds a distance threshold; calculating to obtain the vibration controlling information of the first vibrating device and/or the second vibrating device according to a preset relationship if the distance does not exceed the distance threshold, wherein the preset relationship is a correspondence relationship between the distance and the vibration controlling information.

In some embodiments, the method for prompting position further includes: skipping generating vibration controlling information if the distance exceeds the distance threshold.

In some embodiments, the vibration controlling information is a vibration intensity, and the preset relationship satisfies

$$Vi = ( 1 - \frac{Pi}{Pmax} ) * Vmax ,$$

wherein Pi is the distance between the first game character and the second game character, Pmax is a preset distance threshold, Vmax is a preset vibration frequency threshold, and Vi is the vibration intensity corresponding to that the distance between the first game character and the second game character is Pi.

In some embodiments, the vibration controlling information is a voltage, and the operation of calculating to obtain the vibration controlling information for controlling the vibration of the first vibrating device and/or the second vibrating device according to the distance, includes: calculating to obtain the voltage for controlling the vibration of the first vibrating device and/or the second vibrating device according to the distance.

In some embodiments, the vibration controlling information is an electric current, and the operation of calculating to obtain a vibration controlling information for controlling the vibration of the first vibrating device and/or the second vibrating device according to the distance, includes: calculating to obtain the electric current for controlling the vibration of the first vibrating device and/or the second vibrating device according to the distance.

To achieve the above object, the present disclosure also provides a terminal device. The terminal device includes a display screen including a first prompt area and a second prompt area, a first prompting device corresponding to the first prompt area, a second prompting device corresponding to the second prompt area, a memory configured to store a computer-executable position prompting program, and a processor configured to call a computer-executable displaying program to perform the method for prompting position.

In order to realize the above object, the present disclosure further provides a storage medium, the storage medium stores a computer-executable position prompting program, and the program when being executed by a computer makes the computer perform the method for prompting position as described above.

Compared to the prior art, the method for prompting position of a game character provided by the present disclosure is applied to a terminal device. The terminal device includes a display screen, a first prompting device, and a second prompting device. The display screen includes a first prompt area corresponding to the first prompting device and a second prompt area corresponding to the second prompting device. In the method for prompting position, the position information of the first game character in the game screen is acquired to determine whether the first game character is in the first prompt area or the second prompt area. In case the first game character is in the first prompt area, the first prompting device is controlled to generate the prompt information, and/or in case the first game character is in the second prompt area, the second prompting device is controlled to generate the prompt information. The prompt information gives an early warning to users, which improves the user's gaining experience.

Further, the user manipulates the second game character in the game, the first game character and the second game character are rivals to each other, and the intensity of the prompt information generated by the first prompting device and/or the second prompting device is related to the distance between the first game character and the second game character. The closer the distance between the second game character and the first game character, the stronger the prompt information generated by the first prompting device and/or the second prompting device is, which means that there is a greater probability that the second game character is located in a dangerous environment, and vice versa. By means of changing the intensity of the prompt information, the users who control the second game character may get a better gaining experience.

### BRIEF DESCRIPTION OF THE DRAWINGS

To clearly illustrate the technical solutions that are reflected in various embodiments according to this disclosure, the accompanying drawings intended for the description of the embodiments herein will now be briefly described. It is evident that the accompanying drawings listed in the following description show merely some embodiments according to this disclosure, and that those having ordinary skill in the art will be able to obtain other drawings based on the arrangements shown in these drawings without making inventive efforts.

FIG. 1 is a flow chart of a method for prompting position of a game character in accordance with an embodiment of the present disclosure;

FIG. 2 is a schematic structure diagram of a terminal device in accordance with an embodiment of the present disclosure;

FIG. 3 is another schematic structure diagram of the terminal device in accordance with an embodiment of the present disclosure;

FIG. 4 is a schematic diagram showing a single first game character and a single second game character in a display screen during running game in the terminal device;

FIG. 5 is a schematic diagram showing a plurality of first game characters and a plurality of second game characters in the display screen during running game in the terminal device;

FIG. 6 is a sub flow chart of operation S3 in FIG. 1 in accordance with an embodiment of the present disclosure;

FIG. 7 is a structural block diagram of the terminal device in accordance with an embodiment of the present disclosure.

### DETAILED DESCRIPTION OF THE EXEMPLARY EMBODIMENT

The technical solutions of the embodiments of the present disclosure will be clearly and completely described in the following with reference to the accompanying drawings. It should be understood that the detailed description herein is only used to explain the present disclosure and is not intended to limit the present disclosure.

The terms “first”, “second”, “third”, “fourth”, and the like in the description, claims, and the above-mentioned drawings (if present) are used to distinguish similar objects without defining a specific order or a sequence. It should be understood that the terms used herein are interchangeable where appropriate, so that the embodiments described herein can be implemented in an order other than what is illustrated or described herein. Furthermore, the terms “include” and “have” and any of their variations are intended to cover non-exclusive inclusions, for example, a process, a method, a system, a product, or a device that contains a series of steps or units is not limited to those explicitly listed, those may instead include other steps or units not explicitly listed or inherent to these process, method, product or equipment.

It should be noted that, in the embodiments of the present disclosure, the description which relates to “first”, “second”, etc., is only used to describe technical features, and cannot be understood as expressing or implying their relative importance, sequence, and the quantity of technical features indicated. Therefore, the technical features defined as “first” or “second” can be understood as including at least one technical feature. In addition, the technical solutions between the various embodiments of the present disclosure can be combined with each other, but must be based on those that can be implemented by a person of ordinary skill in the art. If the combination of technical solutions conflicts or cannot be realized, the combination of schemes is considering not exist and is not within the scope of the present disclosure.

The present disclosure provides a method for prompting position of a game character, a terminal device, and a storage medium. The method for prompting position is applied to the terminal device which includes a display screen, a first prompting device, and a second prompting device. The display screen includes a first prompt area which is corresponding to the first prompting device and a second prompt area which is corresponding to the second prompting device. In the method for prompting position, a position information of the first game character in the game screen is acquired to determine whether the first game character is in the first prompt area or the second prompt area. In case the first game character is in the first prompt area, the first prompting device is controlled to generate the prompt information; in case the first game character is in the second prompt area, the second prompting device is controlled to generate the prompt information. The prompt information gives an early warning to users, which improves the user's gaining experience.

Further, the user manipulates the second game character in the game, the first game character and the second game character are rivals to each other, and the intensity of the prompt information generated by the first prompting device and/or the second prompting device is related to the distance between the first game character and the second game character. The closer the distance between the second game character and the first game character, the stronger the prompt information generated by the first prompting device and/or the second prompting device is, which means that there is a greater probability that the second game character is located in a dangerous environment, and vice versa. By means of changing the intensity of the prompt information, the users who control the second game character may get a better gaining experience.

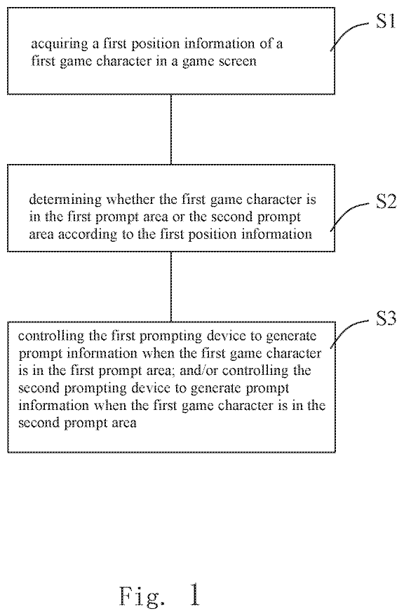

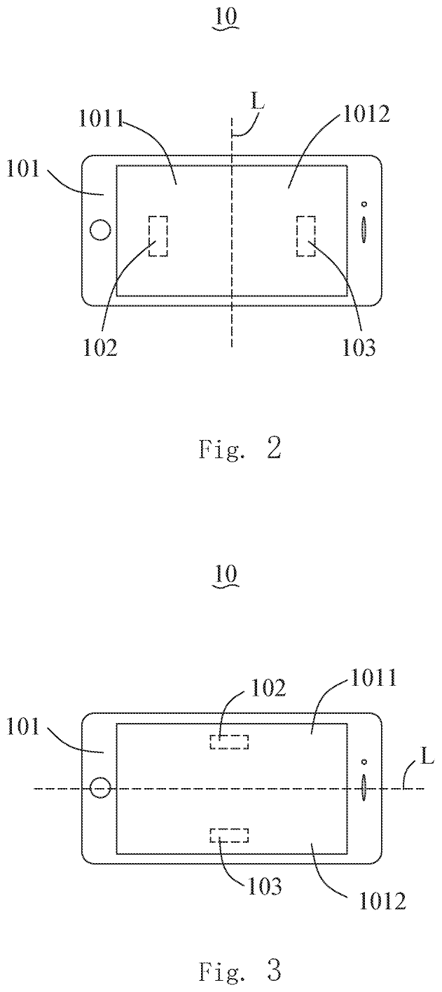

FIG. 1 shows a flow chart of the method for prompting position of a game character according to a first embodiment of the present disclosure, and the method is applied to a terminal device 10 as shown in FIGS. 2 and 3.

Please referring to FIG. 2, the terminal device 10 includes a display screen 101, a first prompting device 102, and a second prompting device 103. The display screen 101 is preferably a touch screen. The display screen 101 is divided into a first prompt area 1011 and a second prompt area 1012 by a dividing line “L” extending along a first direction. The area of the first prompt area 1011 may be smaller than that of the second prompt area 1012, or may be equal to the area of the second prompt area 1012, or may be larger than the area of the second prompt area 1012, which is not limited herein.

Preferably, the area of the first prompt area 1011 is equal to the area of the second prompt area 1012, that is, the first prompt area 1011 and the second prompt area 1012 are symmetrical with each other.

The first prompting device 102 is disposed on the side of the first prompt area 1011 away from the user's touch, and the second prompting device 103 is correspondingly disposed on the side of the second prompt area 1012 away from the user's touch. The first prompting device 102 and/or the second prompting device 103 may be a vibrator or a motor, and is configured to issue a vibration prompt when a driving signal is received.

Please referring to FIG. 3, the dividing line “L” extends along a second direction to divide the display screen 101 into a first prompt area 1011 and a second prompt area 1012, and the first direction and the second direction are perpendicular to each other.

Please referring to FIG. 1, the method for prompting position of a game character includes operations S1 to S3.

Operations S1, a first position information of the first game character in the game screen is acquired.

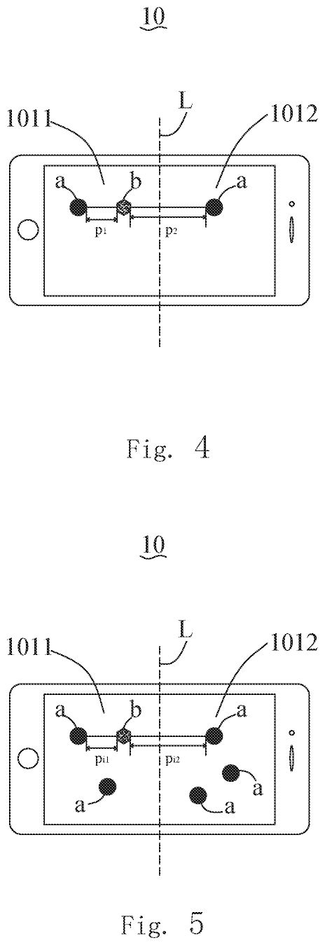

Please referring to FIG. 4, during a game is running in the terminal device 10, the first position information of a first game character “a” in the game screen is obtained through an information collector in the terminal device 10 or a signal output interface of the terminal device 10. The first position information includes a first position coordinate of the first game character in the game screen.

In the exemplary embodiment, the role played by the first game character “a” and a game account in which the terminal device 10 is logging in are hostile characters. The role played by the logged-in game account is hereinafter referred to as a second game character “b”.

Operation S2, whether the first game character is located in the first prompt area or the second prompt area is determined according to the first position information.

Based on the first position information where the first game character “a” is located, it can determine whether the first game character is in the first prompt area 1011 or the second prompt area 1012, or the first prompt area 1011 and the second prompt area 1012 both have the first game character “a”. If the first prompt area 1011 and/or the second prompt area 1012 has the first game character “a”, it means that the first prompt area 1011 and/or the second prompt area 1012 has at least one first game character “a”.

As shown in FIG. 4, that is, it is determined from the position information of the first game character “a” that the first game character “a” is on the left or right side of the dividing line “L”, or the left and right sides of the dividing line “L” both have the game character “a”.

As shown in FIG. 5, the quantity of the first game character “a” located at the left side or the right side of the dividing line L may be one, two, or more.

Operation S3, the first prompting device is controlled to generate prompt information when the first game character is in the first prompt area; and/or the second prompting device is controlled to generate prompt information when the first game character is in the second prompt area.

Specifically, in case the first game character “a” appears or exists in the first prompt area 1011, the terminal device 10 controls the first prompting device 102 to generate the prompt information to prompt the user that there is a potential threat existed in the first prompt area 1011, so that the user can control the second game character “b” to take precautions in advance.

In case the first game character “a” appears or exists in the second prompt area 1012, the terminal device 10 controls the second prompting device 103 to generate the prompt information to prompt the user that there is a potential threat existed in the second prompt area 1012.

In case the first game character “a” appears or exists in both the first prompt area 1011 and the second prompt area 1012, the terminal device 10 controls both the first prompting device 102 and the second prompting device 103 to generate corresponding prompt information respectively, to prompt the user that there are potential threats existed in the first prompt area 1011 and the second prompt area 1012.

Each of the first prompting device 102 and the second prompting device 103 may be a vibrating device, a sound generator, or a color changing device, which is configured to send corresponding prompt information, such as vibration, sound, or color change.

In some embodiments, the first prompting device 102 is a first vibrating device, and the second prompting device 103 is a second vibrating device. In operation S3, the operation of controlling the first prompting device and/or the second prompting device to generate prompt information specifically includes controlling the first vibrating device and/or the second vibrating device to vibrate.

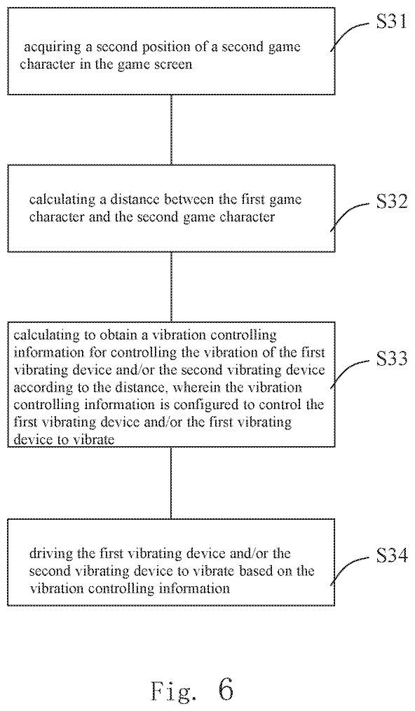

FIG. 6 shows a sub flow chart of operation S3 according to an embodiment.

In some embodiments, the operation S3 of controlling the first prompting device and/or the second prompting device to vibrate, specifically includes operations S31 to S34.

Operation S31, a second position information of a second game character in the game screen is acquired.

As shown in FIG. 4, during a game is running in the terminal device 10, the second position information of a second game character “b” in the game screen is obtained through an information collector in the terminal device 10 or a signal output interface of the terminal device 10. The second position information includes a second position coordinate of the second game character “b” in the game screen.

Operation S32, a distance between the first game character and the second game character is calculated.

Specifically, the distance between the first game character “a” and the second game character “b” is acquired based on the first position information of the first game character “a” and the second position information of the second game character “b”.

Operation S33, a vibration controlling information for controlling the vibration of the first vibrating device and/or the second vibrating device is obtained by calculating according to the distance, wherein the vibration controlling information is configured to control the first vibrating device and/or the first vibrating device to vibrate.

The vibration controlling information of the first vibrating device and the second vibrating device is calculated based on the distance between the first game character “a” and the second game character “b” and a corresponding preset relationship, and the preset relationship is a correspondence relationship between the distance and the vibration controlling information. That is, the vibration controlling information of the first vibrating device and/or the second vibrating device can be obtained via acquiring the distance between the first game character “a” and the second game character “b”. The vibration controlling information is configured to control the first vibrating device and/or the second vibrating device vibrating.

In some embodiments, operation S33 includes operations S331 to S333.

Operation S331, whether the distance exceeds a distance threshold is determined, and operation S332 is implemented if the distance does not exceed the distance threshold, otherwise operation S333 is implemented.

Operation S332, the vibration controlling information of the first vibrating device and/or the second vibrating device is obtained by calculating based on the preset relationship, wherein the preset relationship is a correspondence relationship between the distance and the vibration controlling information.

Operation S333, skip generating the vibration controlling information.

As shown in FIG. 4, there is a first game character “a” in both the first prompt area 1011 and the second prompt area 1012, a distance between the first game character “a” in the first prompt area 1011 and the second game character “b” is recorded as p1, the distance between the first game character “a” in the second prompt area 1012 and the second game character “b” is recorded as p2.

In case the distance p1 and the distance p2 exceed the distance threshold, it is judged that the first game character “a” in the first prompt area 1011 and the second prompt area 1012 does not pose a threat to the second game character “b” for the moment, and it is not need to control the first vibrating device and the second vibrating device to vibrate.

In case the distance p1 and the distance p2 do not exceed the distance threshold, it is determined that the first game character “a” in the first prompt area 1011 and the second prompt area 1012 poses a threat to the second game character “b”, and the vibration controlling information of the first vibrating device and/or the second vibrating device is calculated according to the preset relationship to control the first vibrating device and/or the second vibrating device to vibrate.

In case the distance p1 does not exceed the distance threshold and the distance p2 exceeds the distance threshold, it is determined that the first game character “a” in the first prompt area 1011 poses a threat to the second game character “b”, and the vibration controlling information of the first vibrating device is calculated according to the preset relationship to control the first vibrating device vibrating.

As shown in FIG. 5, in case there are a plurality of first game characters “a” in the first prompt area 1011 and/or the second prompt area 1012, as long as any one of the distances Pi between one of the first game character “a” in the first prompt area 1011 and the second game character “b” is less than or equal to the distance threshold, a corresponding vibration controlling information will be acquired according to a current distance between the first game character “a” and the second game character “b” which is the minimum value of the distances Pi, to control the first vibrating device to vibrate.

Simultaneously, as long as any one of the distances Pi between one of the first game character “a” in the second prompt area 1011 and the second game character “b” is less than or equal to the distance threshold, a corresponding vibration controlling information will be acquired according to a current distance between the first game character “a” and the second game character “b” which is the minimum value of the distances Pi, to control the second vibrating device to vibrate.

In some embodiments, the vibration controlling information is a vibration intensity, and the preset relationship in operation S332 satisfies:

$$Vi = ( 1 - \frac{Pi}{Pmax} ) * Vmax ,$$

wherein Pi is the distance between the first game character and the second game character, Pmax is the preset distance threshold, Vmax is a preset vibration frequency threshold, and Vi is the vibration intensity corresponding to that the distance between the first game character and the second game character is Pi, namely the current vibration intensity. The vibration amplitude of the first vibrating device and/or the second vibrating device is controlled by controlling the vibration intensity, so that user can more clearly feel a distance changing between the first game character “a” and the second game character “b” in advance to prepare for the game, so that the user's gaining experience is greatly improved.

In some embodiments, the vibration controlling information is a vibration frequency, and the preset relationship in operation S332 satisfies:

$$Vi = ( 1 - \frac{Pi}{Pmax} ) * Vmax ,$$

wherein Pi is a distance between the first game character and the second game character, Pmax is the preset distance threshold, Vmax is the preset vibration frequency threshold, and Vi is the vibration frequency corresponding to that the distance between the first game character and the second game character is Pi. The vibration amplitude of the first vibrating device and/or the second vibrating device is controlled by controlling the vibration frequency. The magnitude of the distance Pi between the first game character “a” and the second game character “b” is configured to control the corresponding vibration amplitude of the first vibration device and/or the second vibration device.

In some embodiments, the vibration controlling information is a voltage, and the operation S332 of calculating to obtain the vibration controlling information for controlling the vibration of the first vibrating device and/or the second vibrating device according to the distance, includes:

calculating to obtain the voltage for controlling the vibration of the first vibrating device and/or the second vibrating device based on the distance and a preset relationship, wherein the preset relationship is a correspondence relationship between the distance and the voltage. By controlling the driving voltage, the vibration amplitude of the first vibrating device and/or the second vibrating device may be controlled.

In some embodiments, the vibration controlling information is an electric current, and the operation S332 of calculating to obtain a vibration controlling information for controlling the vibration of the first vibrating device and/or the second vibrating device according to the distance, includes: calculating to obtain the electric current for controlling the vibration of the first vibrating device and/or the second vibrating device based on the distance and a preset relationship, wherein the preset relationship is a correspondence relationship between the distance and the electric current. By controlling the driving electric current, the vibration amplitude of the first vibrating device and/or the second vibrating device may be controlled.

Operation S34, the first vibrating device and/or the second vibrating device is driven to vibrate based on the vibration controlling information.

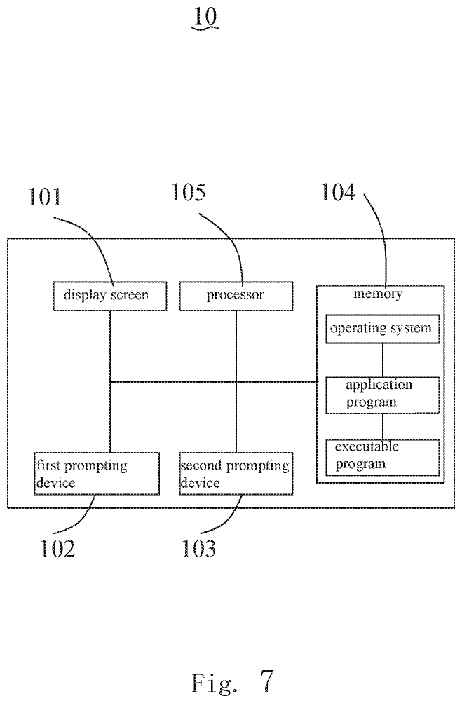

Please referring to FIG. 7, in some embodiments, the terminal device 10 includes a display screen 101, a first prompting device 102, a second prompting device 103, a memory 104, and a processor 105.

The display screen 101 includes a first prompt area corresponding to the first prompting device and a second prompt area corresponding to the second prompting device. The display screen 101, the first prompting device 102, the second prompting device 103, and the memory 104 are connected to the processor 105 through a bus. The bus may be a peripheral component interconnect (PCI) bus or an extended industry standard architecture (EISA) bus. The bus may include an address bus, a data bus, a control bus, and the like.

The memory 104 includes at least one type of readable storage medium. The readable storage medium includes a flash memory, a hard disk, a multimedia card, a card-type memory (for example, an SD or DX memory, etc.), a magnetic memory, a magnetic disk, and an optical disk. In some embodiments, the memory 104 may be an internal storage unit of the terminal device 10, such as a hard disk of the terminal device 10. In other embodiments, the memory 104 may also be an external storage device of the terminal device 10, such as a plug-in hard disk, a smart media card (SMC), a secure digital (SD) card, and a flash Card, etc. Further, the memory 104 may include both the internal storage unit of the terminal device 10 and the external storage device. The memory 104 is configured to store application software installed on the terminal device 10 and various types of data, such as the aforementioned position prompting program, and the like.

In some embodiments, the processor 105 may be a central processing unit (CPU), a controller, a microcontroller, a microprocessor, or other data processing chips. The processor 105 is configured to run program codes stored in the memory 104 or to process data, such as the position prompting program, etc., to implement the operations of the method for prompting position.

The present disclosure further provides a storage medium, the storage medium stores a computer-executable position prompting program, and the program when being executed by a computer makes the computer perform the method for prompting position as described above.

It is to be understood, however, that even though numerous characteristics and advantages of the present exemplary embodiment have been set forth in the foregoing description, together with details of the structures and functions of the embodiment, the disclosure is illustrative only. Improvements may be made for those of ordinary skill in the art without departing from the concept of the disclosure, but these are all within the scope of the disclosure.

What is claimed is:

1. A method for prompting position of a game character, applied to a terminal device, wherein the terminal device comprises a display screen, a first prompting device, and a second prompting device; the display screen comprises a first prompt area and a second prompt area; the first prompting device is set to correspond to the first prompt area, and the second prompting device is set to correspond to the second prompt area; the method for prompting position comprises:
acquiring a first position information of a first game character in a game screen;
determining whether the first game character is in the first prompt area or the second prompt area according to the first position information;
controlling the first prompting device to generate prompt information when the first game character is in the first prompt area; and/or
controlling the second prompting device to generate prompt information when the first game character is in the second prompt area.

2. The method for prompting position according to claim 1, wherein the first prompting device and the second prompting device are a first vibrating device and a second vibrating device respectively, and controlling the first prompting device and/or the second prompting device to generate prompt information specifically comprises: controlling the first vibrating device and/or the second vibrating device to vibrate.

3. The method for prompting position according to claim 2, wherein the operation of controlling the first vibrating device and/or the second vibrating device to vibrate comprises:
acquiring a second position of a second game character in the game screen;
calculating a distance between the first game character and the second game character;
calculating to obtain a vibration controlling information for controlling the vibration of the first vibrating device and/or the second vibrating device according to the distance, wherein the vibration controlling information is configured to control the first vibrating device and/or the first vibrating device to vibrate; and
driving the first vibrating device and/or the second vibrating device to vibrate based on the vibration controlling information.

4. The method for prompting position according to claim 3, wherein the operation of calculating to obtain the vibration controlling information for controlling the vibration of the first vibrating device and/or the second vibrating device according to the distance, comprises:
determining whether the distance exceeds a distance threshold;
calculating to obtain the vibration controlling information of the first vibrating device and/or the second vibrating device according to a preset relationship if the distance does not exceed the distance threshold, wherein the preset relationship is a correspondence relationship between the distance and the vibration controlling information.

5. The method for prompting position according to claim 4, further comprising:
skipping generating vibration controlling information if the distance exceeds the distance threshold.

6. The method for prompting position according to claim 4, wherein the vibration controlling information is a vibration intensity, and the preset relationship satisfies:
$$Vi = ( 1 - \frac{Pi}{Pmax} ) * Vmax ,$$
wherein Pi is the distance between the first game character and the second game character, Pmax is a preset distance threshold, Vmax is a preset vibration frequency threshold, and Vi is the vibration intensity corresponding to that the distance between the first game character and the second game character is Pi.

7. The method for prompting position according to claim 4, wherein the vibration controlling information is a voltage, and the operation of calculating to obtain the vibration controlling information for controlling the vibration of the first vibrating device and/or the second vibrating device according to the distance, comprises:
calculating to obtain the voltage for controlling the vibration of the first vibrating device and/or the second vibrating device according to the distance.

8. The method for prompting position according to claim 4, wherein the vibration controlling information is an electric current, and the operation of calculating to obtain a vibration controlling information for controlling the vibration of the first vibrating device and/or the second vibrating device according to the distance, comprises:
calculating to obtain the electric current for controlling the vibration of the first vibrating device and/or the second vibrating device according to the distance.

9. A terminal device, comprising:
a display screen comprising a first prompt area and a second prompt area;
a first prompting device corresponding to the first prompt area;
a second prompting device corresponding to the second prompt area;
a memory configured to store a computer-executable position prompting program; and
a processor configured to call a computer-executable displaying program to perform a method for prompting position of a game character; the method for prompting position comprising:
acquiring a first position information of a first game character in a game screen;
determining whether the first game character is in the first prompt area or the second prompt area according to the first position information;
controlling the first prompting device to generate prompt information when the first game character is in the first prompt area; and/or
controlling the second prompting device to generate prompt information when the first game character is in the second prompt area.

10. The terminal device according to claim 9, wherein the first prompting device and the second prompting device are a first vibrating device and a second vibrating device respectively, and controlling the first prompting device and/or the second prompting device to generate prompt information specifically comprises: controlling the first vibrating device and/or the second vibrating device to vibrate.

11. The terminal device according to claim 10, wherein the operation of controlling the first vibrating device and/or the second vibrating device to vibrate comprises:
acquiring a second position of a second game character in the game screen;
calculating a distance between the first game character and the second game character;
calculating to obtain a vibration controlling information for controlling the vibration of the first vibrating device and/or the second vibrating device according to the distance, wherein the vibration controlling information is configured to control the first vibrating device and/or the first vibrating device to vibrate; and
driving the first vibrating device and/or the second vibrating device to vibrate based on the vibration controlling information.

12. The terminal device according to claim 11, wherein the operation of calculating to obtain the vibration controlling information for controlling the vibration of the first vibrating device and/or the second vibrating device according to the distance, comprises:
determining whether the distance exceeds a distance threshold;
calculating to obtain the vibration controlling information of the first vibrating device and/or the second vibrating device according to a preset relationship if the distance does not exceed the distance threshold, wherein the preset relationship is a correspondence relationship between the distance and the vibration controlling information.

13. The terminal device according to claim 12, wherein the method for prompting position further comprises: skipping generating vibration controlling information if the distance exceeds the distance threshold.

14. The terminal device according to claim 12, wherein the vibration controlling information is a vibration intensity, and the preset relationship satisfies:
$$Vi = ( 1 - \frac{Pi}{Pmax} ) * Vmax ,$$
wherein Pi is the distance between the first game character and the second game character, Pmax is a preset distance threshold, Vmax is a preset vibration frequency threshold, and Vi is the vibration intensity corresponding to that the distance between the first game character and the second game character is Pi.

15. The terminal device according to claim 12, wherein the vibration controlling information is a voltage, and the operation of calculating to obtain the vibration controlling information for controlling the vibration of the first vibrating device and/or the second vibrating device according to the distance, comprises: calculating to obtain the voltage for controlling the vibration of the first vibrating device and/or the second vibrating device according to the distance.

16. The terminal device according to claim 12, wherein the vibration controlling information is an electric current, and the operation of calculating to obtain a vibration controlling information for controlling the vibration of the first vibrating device and/or the second vibrating device according to the distance, comprises: calculating to obtain the electric current for controlling the vibration of the first vibrating device and/or the second vibrating device according to the distance.

17. A storage medium, wherein the storage medium stores a computer-executable position prompting program, and the program when being executed by a computer makes the computer perform a method for prompting position of a game character;
the method for prompting position comprising:
acquiring a first position information of a first game character in a game screen;
determining whether the first game character is in the first prompt area or the second prompt area according to the first position information;
controlling the first prompting device to generate prompt information when the first game character is in the first prompt area; and/or
controlling the second prompting device to generate prompt information when the first game character is in the second prompt area.
